(19) United States
(12) Patent Application Publication
(10) Pub. No.: US 2025/0219317 A1
(43) Pub. Date: Jul. 3, 2025

(54) FLUSH MOUNTED WALL SOCKET

(71) Applicant: Chongjun Wang, Pu'er (CN)

(72) Inventor: Chongjun Wang, Pu'er (CN)

(21) Appl. No.: 19/000,812

(22) Filed: Dec. 24, 2024

(30) Foreign Application Priority Data
Dec. 29, 2023 (CN) 202323630076.6

(51) Int. Cl. H01R 13/512; H01R 13/508; H01R 13/52; H01R 13/74; H02G 3/12

(52) U.S. Cl. CPC H01R 13/512; H01R 13/508; H01R 13/5213; H01R 13/748; H02G 3/12

(57) ABSTRACT

Disclosed is a flush mounted wall socket, comprising an American standard ordinary junction box, a pre-embedded bracket, a connection assembly, a socket box, screws, a socket cover. The American standard ordinary junction box is movably provided with the pre-embedded bracket, the connection assembly is movably arranged between the pre-embedded bracket and the socket box, and the socket cover and the socket box are connected by the screws. The pre-embedded bracket is provided in different styles and sizes. The connection assembly is provided with a large spacer, small spacers and springs. The large spacer is provided with one, numbers of the small spacers, the springs and the screws are not limited, and the numbers of the small spacers, the springs and the screws are consistent. The socket cover is fixedly provided with an access hole in the middle in addition to conventional holes.

### CROSS-REFERENCE TO RELATED APPLICATIONS

This application claims priority to Chinese Patent Application No. 202323630076.6, filed on Dec. 29, 2023, which is hereby incorporated by reference in its entirety.

### TECHNICAL FIELD

The present disclosure relates to building electrical design, specifically to a flush mounted wall socket.

### BACKGROUND

Flush mounted wall sockets relate to building electrical design. In building electrical design, it is often necessary to install sockets on the wall to ensure safety and to control circuit when needed. However, conventional socket installation methods often need to drill holes in the wall, which not only damages the wall structure, but also causes safety hazards. To solve this problem, flush mounted wall sockets have been developed. Flush mounted wall sockets are designed to be installed flush with the wall, thus avoiding the need to drill holes in the wall. This design not only improves installation efficiency, but also reduces structural damage to the wall and safety hazards.

However, there are very few types of flush mounted wall sockets on the market at present, and the related technology has certain defects, such as low integration, low flexibility, low safety performance, laborious installation, difficult maintenance process, and not beautiful enough.

### SUMMARY

An objective of the present disclosure is to provide a flush mounted wall socket to overcome the above technical defects, i.e., low integration, low flexibility, low safety performance, laborious installation, difficult maintenance process, and not beautiful enough.

In order to achieve the above objective, the present disclosure provides a flush mounted wall socket, comprising an American standard ordinary junction box, a pre-embedded bracket, a pre-embedded safety door, a connection assembly, a socket box, screws, a socket cover, wherein the American standard ordinary junction box is movably provided with the pre-embedded bracket, the connection assembly is movably arranged between the pre-embedded bracket and the socket box, and the connection assembly and the socket box are connected by the screws.

Further, the pre-embedded bracket is provided in different styles and specifications.

Further, the connection assembly is provided with spacers and springs.

Further, numbers of the spacers, the springs and the screws are not limited, and the numbers of the spacers, the springs and the screws are consistent.

Further, the socket cover is fixedly provided with an access hole in the middle in addition to conventional holes, and the socket cover is round and square in shape.

Further, connection between the socket box and the socket cover is magnet adsorption or direct mounting.

Compared with the prior art, the present disclosure has a high degree of integration, specifically, the embodiment integrates a number of components such as the American standard ordinary junction box, the pre-embedded bracket, pre-embedded safety door, the connection assembly, the socket box, the screws and the socket cover, and simplifies the installation process and improves the efficiency; the present disclosure has a good degree of flexibility, specifically, the pre-embedded bracket is provided in different styles and specifications, so the embodiment can be adaptable to different installation environments and needs, and has a wider scope of application; the present disclosure has strong safety performance, specifically, the connection assembly is provided with spacers and springs, so the stability and durability of the connection assembly can be increased, and at the same time the safety hazards due to the movement of the connection assembly can be reduced; the present disclosure is easy to install, specifically, numbers of the spacers, the springs and the screws are not limited, and the numbers of the spacers, the springs and the screws are consistent, which makes the installation process more standardized and simple; in addition, the present disclosure is easy to maintenance, specifically, in addition to the conventional holes on the socket cover, the socket cover is fixedly provided with an access hole in the middle, which makes maintenance and repair easier.

### BRIEF DESCRIPTION OF DRAWINGS

FIG. 1 is an exploded schematic structural diagram of a flush mounted wall round socket of the present disclosure in the first mounting method.

FIG. 2 is a detailed enlarged exploded schematic structural diagram of a flush mounted wall round socket of the present disclosure in the first mounting method.

FIG. 3 is an exploded schematic structural diagram of a flush mounted wall round socket of the present disclosure in the second mounting method.

FIG. 4 is a detailed enlarged exploded schematic structural diagram of a flush mounted wall round socket of the present disclosure in the second mounting method.

FIG. 5 is an exploded schematic structural diagram of a flush mounted wall square socket of the present disclosure in the first mounting method.

FIG. 6 is a detailed enlarged exploded schematic structural diagram of a flush mounted wall square socket of the present disclosure in the first mounting method.

FIG. 7 is an exploded schematic structural diagram of a flush mounted wall square socket of the present disclosure in the second mounting method.

FIG. 8 is a detailed enlarged exploded schematic structural diagram of a flush mounted wall square socket of the present disclosure in the second mounting method.

FIG. 9 shows a schematic diagram of a round socket cover and a round socket box of the round socket of the present disclosure.

FIG. 10 is a schematic diagram of a square socket box and a round socket box of the present disclosure.

FIG. 11 is a schematic diagram of installation effect of a flush mounted wall socket of the present disclosure.

### DESCRIPTION OF EMBODIMENTS

In the following, the technical scheme in this disclosure will be clearly and completely described with reference to the drawings in this application embodiment. Obviously, the described embodiments are only part of the embodiments of this application, not all of them. Based on the embodiments in this application, all other embodiments obtained by ordinary technicians in the field without creative work are within the scope of protection of this application.

In the description of this application, it should be understood that the azimuth or positional relationship indicated by the terms “longitudinal”, “transverse”, “upper”, “lower”, “front”, “rear”, “left”, “right”, “vertical”, “horizontal”, “top”, “bottom”, “inner”, “outer” and so on is based on the azimuth or positional relationship shown in the drawings for describing this application, rather than indicating or implying that the device or element must have a specific orientation, be constructed and operated in a specific orientation, so it cannot be understood as a limitation of the present application. Furthermore, the terms “first”, “second”, “third”, etc. are used only for purposes of differentiation and description, and are not to be understood as indicating or implying relative importance.

In addition, the terms “horizontal”, “vertical”, “overhanging”, etc., do not imply that the component is required to be absolutely horizontal or overhanging, but may be slightly inclined. For example, “horizontal” simply means that it is oriented more horizontally than “vertical” and does not mean that the structure must be perfectly horizontal, but may be slightly inclined.

In the description of embodiments of the present disclosure, “plurality” represents at least two.

In the description of embodiments of the present disclosure, it is also noted that the terms “arranged”, “mounted”, and “connected” are used unless otherwise expressly specified and limited. The term “connected” are to be understood in a broad sense, for example, the components may be either fixedly connected, removably connected, or integrally connected; the components may be either mechanically or electrically connected; the components may be either directly connected, indirectly connected via an intermediary medium, or connected internally within the two elements. For those of ordinary skill in the art, the specific meaning of the above terms in the present disclosure may be understood on a case-by-case basis.

### Embodiments

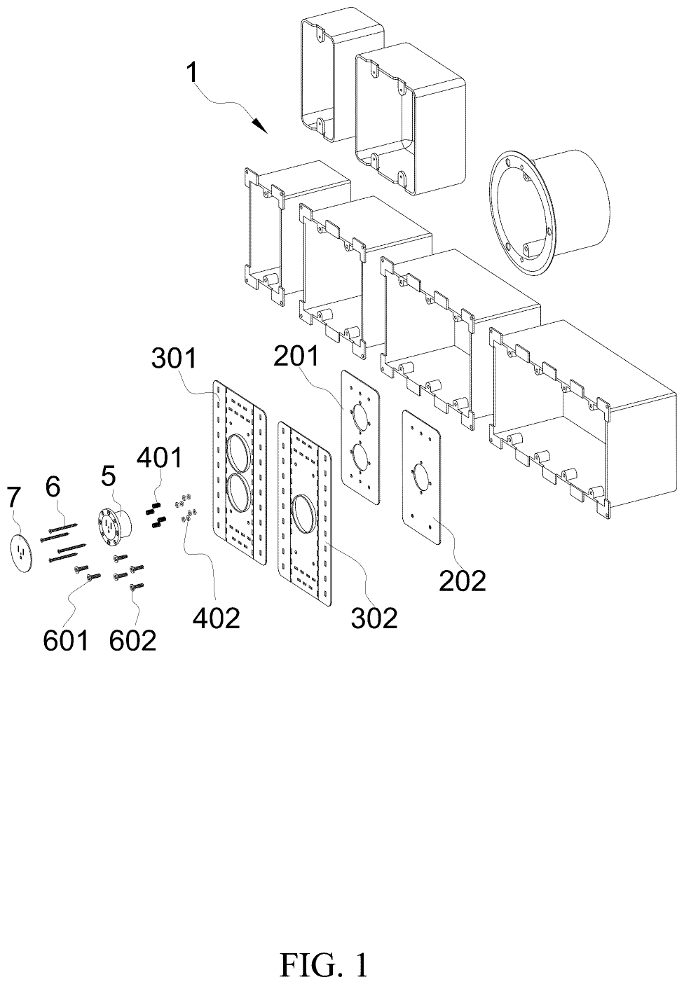

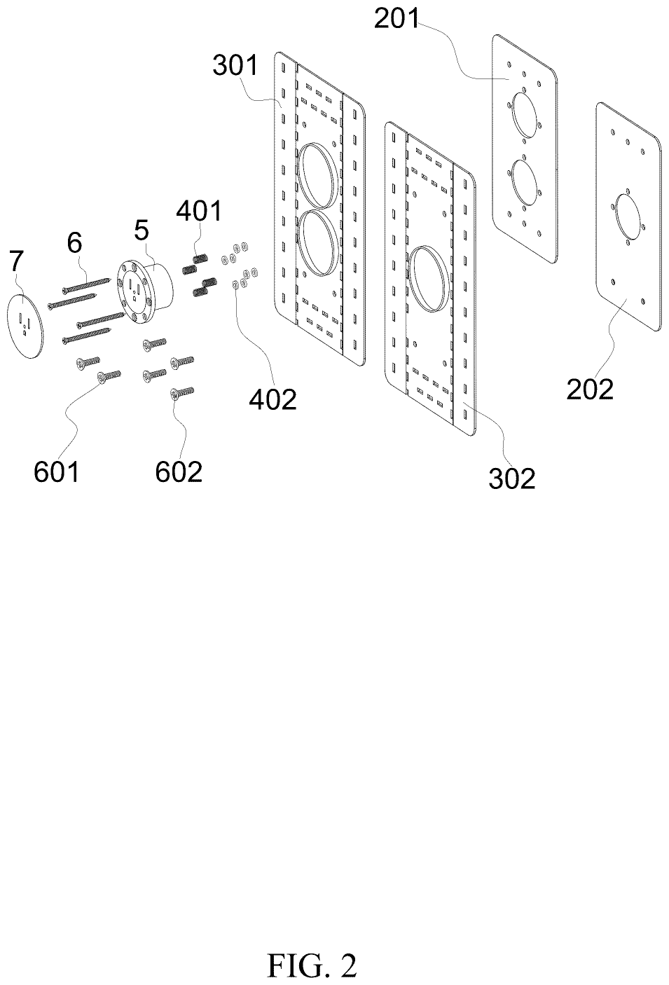

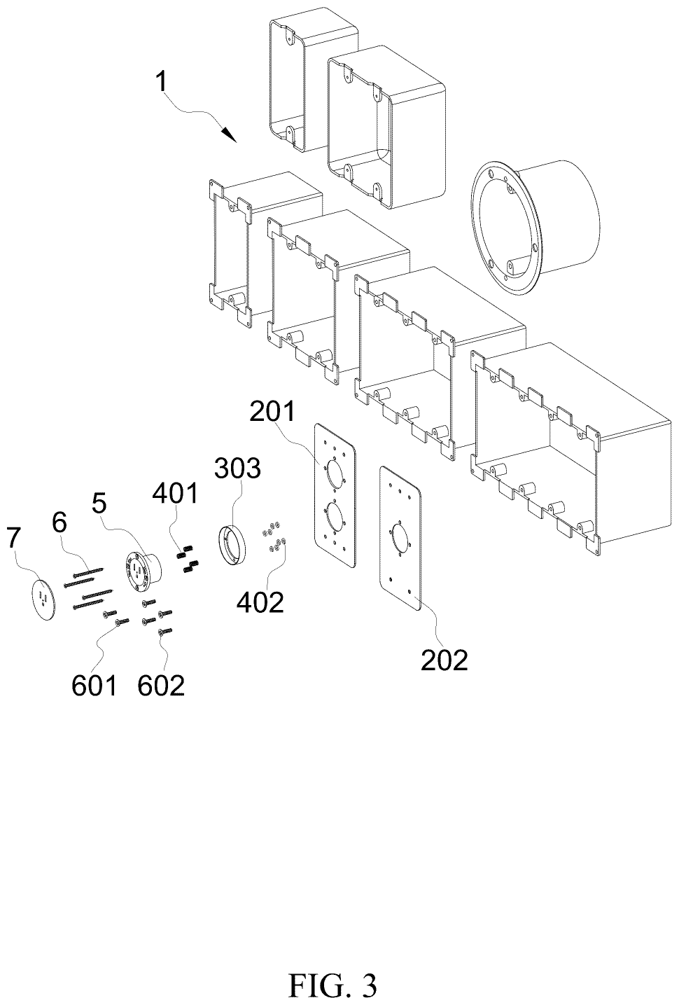

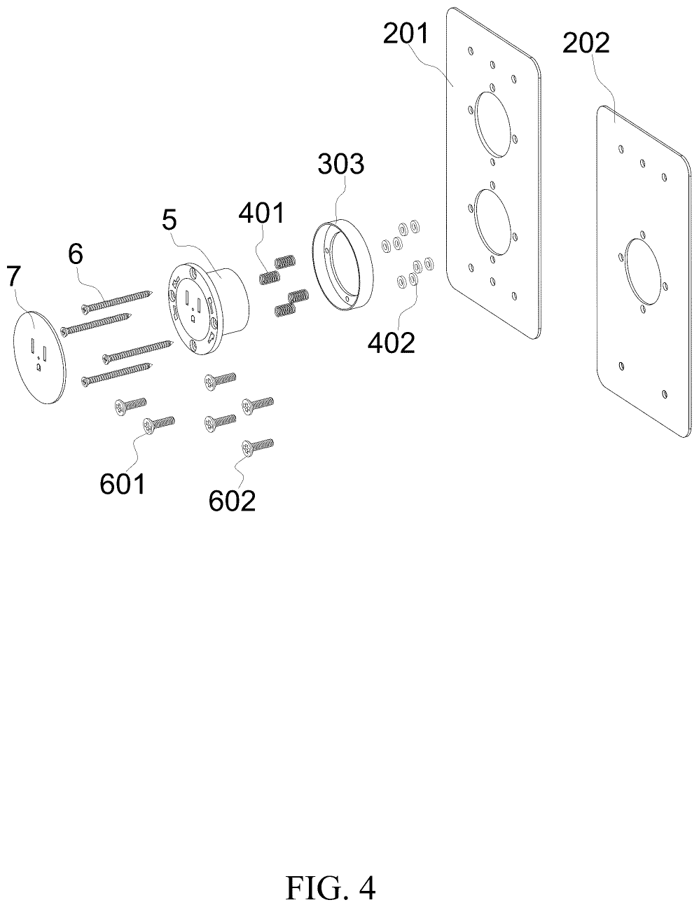

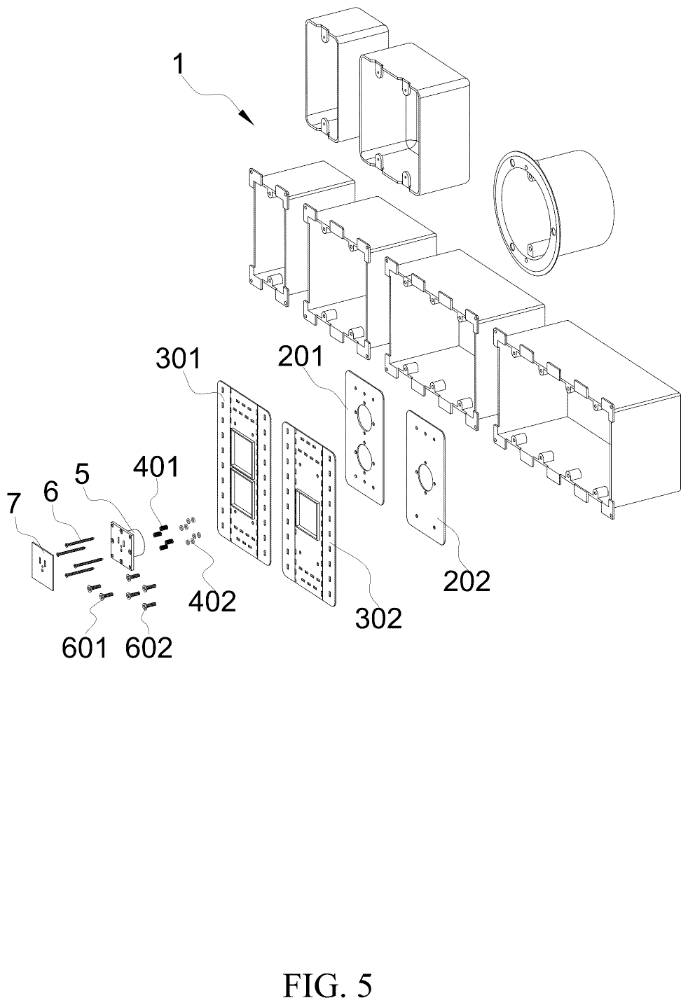

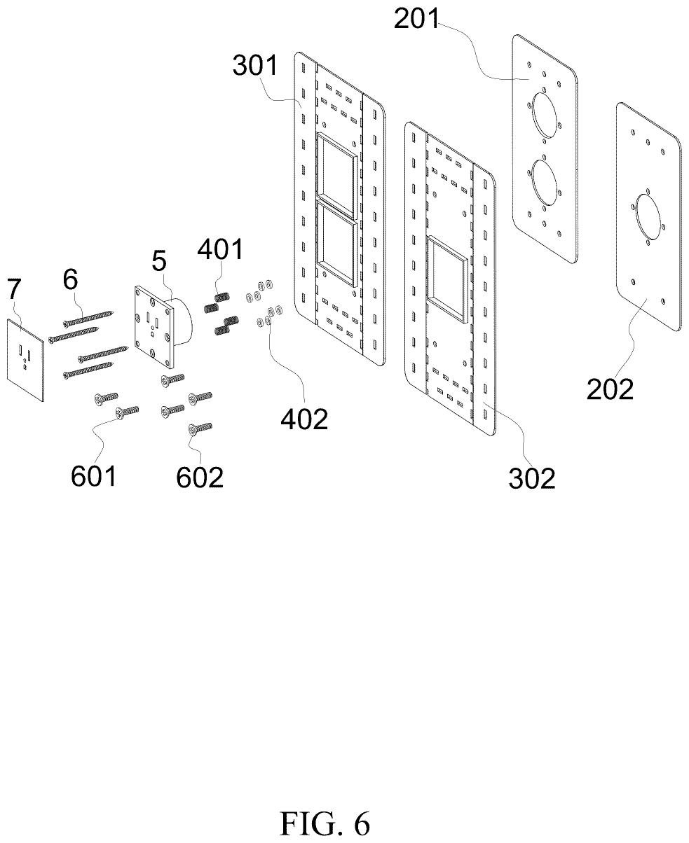

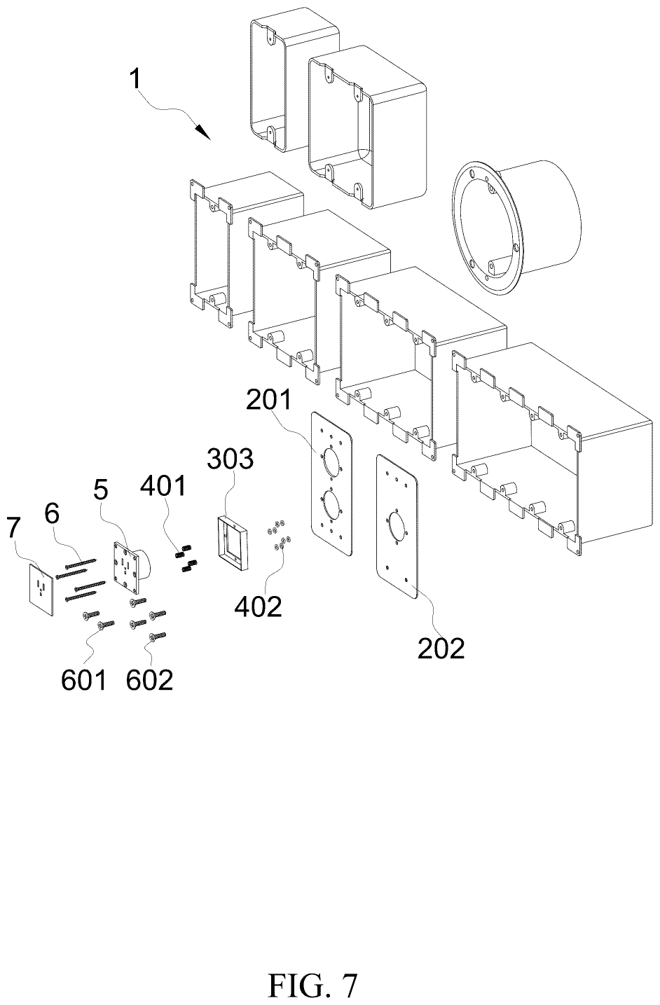

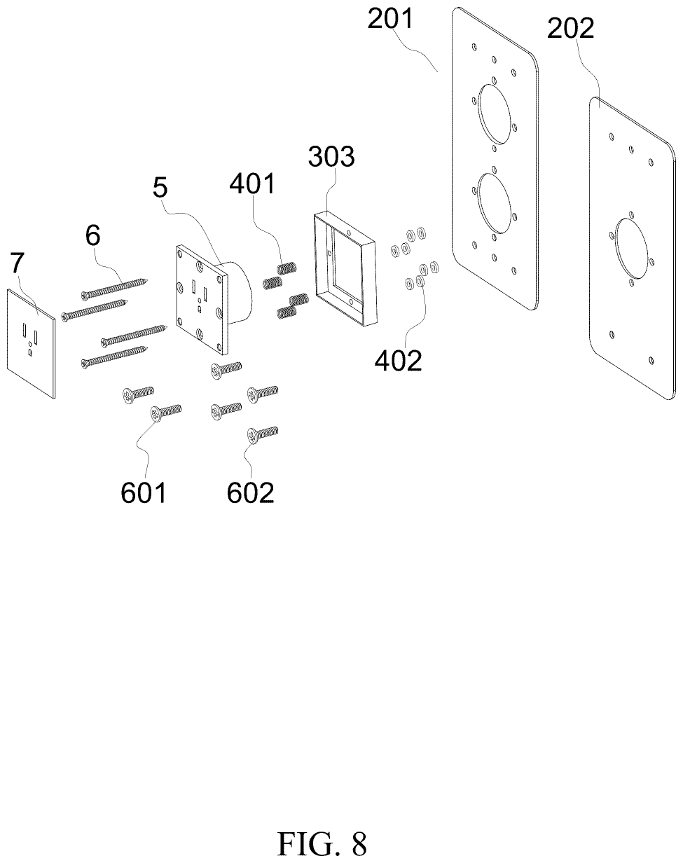

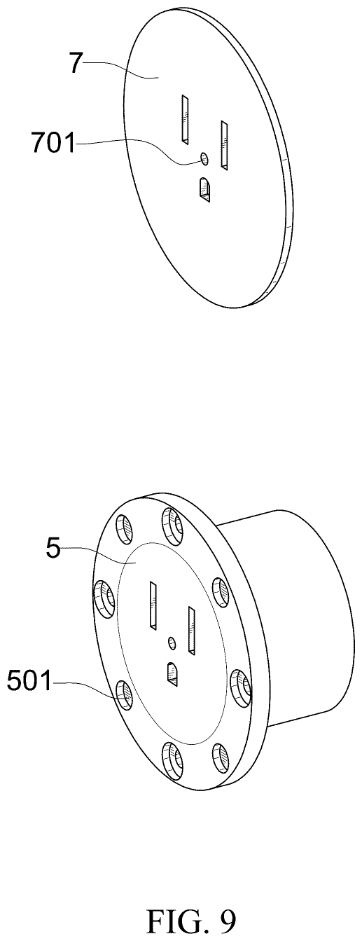

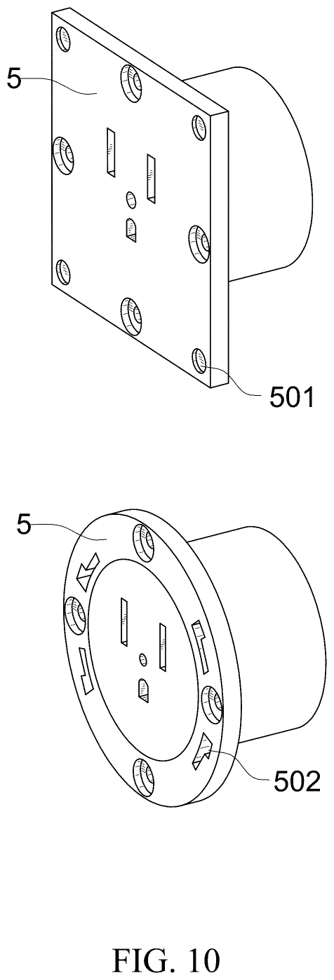

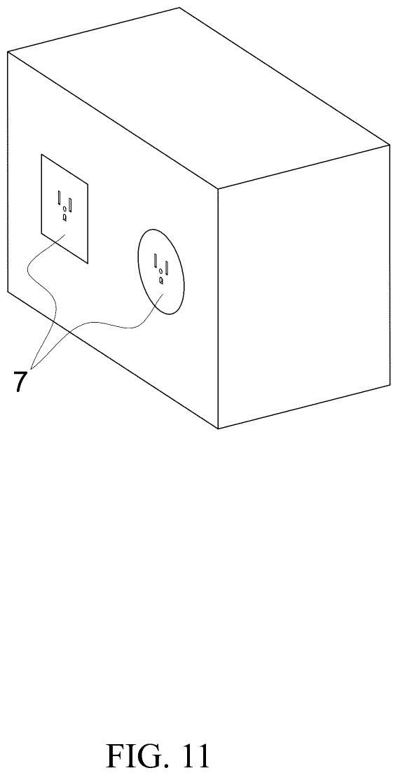

As shown in FIG. 1-FIG. 11, a flush mounted wall socket, comprising an American standard ordinary junction box 1, a pre-embedded bracket 201, 202, a pre-embedded safety door 301, 302 or 303 a connection assembly (specifically, springs 401 and spacers 402), a socket box 5, screws 6, a socket cover 7, wherein the American standard ordinary junction box 1 is movably provided with the pre-embedded bracket 201 or 202 (the specific selection is based on the number of sockets), the pre-embedded safety door 301, 302 or 303 is determined by selecting a round socket box or a square socket box, and the connection assembly (specifically, springs 401 and spacers 402) is movably arranged between the pre-embedded bracket 301, 302 or 303 and the socket box 5, where all parts except the socket cover7 are connected by the screws 6, socket cover 7 and socket box 5 are connected by magnet adsorption 501 or knobs 502 (square socket cover may only be connected by magnet adsorption 501).

American standard ordinary junction box 1 is fully adapted to the socket and accessories.

The pre-embedded bracket is provided in two styles and specifications, in which pre-embedded bracket 201 is suitable for double-seat sockets and pre-embedded bracket 202 is suitable for single-seat sockets.

The pre-embedded safety door is provided in three styles and specifications, in which, the pre-embedded safety doors 301 and 302 are used for installing new sockets and being pre-embedded into the wall and painted, and the pre-embedded safety door 303 is suitable for remodeling the old wall and being embedded into the wall and painted; different pre-embedded doors are used for different installation scenarios to ensure that the pre-embedded safety door is flush with the wall after installation.

The connection assembly is provided with springs 401 and spacers 402, and is used to adjusting the depth distance between the socket box and the wall.

The socket box 5 is provided with two shapes: square and round. It is necessary to choose the pre-embedded safety doors 301, 302, 303, taking into account the shape and number of socket boxes. The screws 6 (4 screws 6 used in this embodiment) are used for mounting the socket box 5 on the pre-embedded bracket after passing through the socket box 5 and the connecting components (spring 401, spacer 402), and for adjusting the depth distance between the socket box 5 and the wall. Screws 601 (2 screws 601 used in this embodiment) are used to attach the pre-embedded bracket to the American standard ordinary junction box. Screws 602 (4 screws 602 used in this embodiment) are used to secure the pre-embedded safety doors (301, 302, 303) to the pre-embedded bracket 2.

In addition to conventional holes, the socket cover 7 is fixedly provided with an access hole 701 in the middle, which is used to take out the socket cover 7, and the socket cover 7 is round and square in shape.

In the specific implementation process, the steps are as follows:
S1: selecting pre-embedded bracket 201 or 202 in conjunction with the number of sockets, and mounting the pre-embedded bracket 201 or 202 to an American standard ordinary junction box by means of screws 601;
S2: selecting the pre-embedded safety doors 301, 302 or 303 by selecting the round socket box 5 or the square socket box 5, and mounting the corresponding safety door on the pre-embedded bracket by means of the screws 602, where pre-embedded safety doors 301 and 302 are suitable for the installation of new sockets (wall painting after pre-embedding) and 303 is suitable for the replacement of old sockets with the socket of the disclosure (wall painting after installation of pre-embedded safety door 303);
S3: painting the wall body, installing socket box 5 and connection assembly on the pre-embedded safety door 201 or 201 by screws 6;
S4: adjusting the connection assembly by the screws 6 to obtain a proper position (that is the socket cover 7 is flush with the wall) between the socket box 5 and the pre-embedded safety door 201 or 202 to benefit the installation of socket cover 7; and
S5: installing the socket cover 7 on the socket box 5, where the socket cover 7 is available in two mounting methods: magnet adsorption 501 and knobs 502 (square socket cover is only available in magnet adsorption 501), and the access hole in the middle of the socket cover 6 is used to hook out the magnetic socket cover 7 (if the socket cover 7 is installed through the knobs 502, the socket cover 7 may be removed by rotating), which is convenient for later replacement or maintenance.

Although the embodiments of the invention have been described with reference to the accompanying drawings, the invention is not limited to the above-mentioned specific embodiments, which are only illustrative and not restrictive, and ordinary technicians in the field may make more forms under the inspiration of the invention without departing from the purpose of the invention and the scope defined by the claims, all of which are within the scope of protection of the invention.

What is claimed is:

1. A flush mounted wall socket, comprising an American standard ordinary junction box, a pre-embedded bracket, a pre-embedded safety door, a connection assembly, a socket box, screws, a socket cover, wherein the American standard ordinary junction box is movably provided with the pre-embedded bracket, the connection assembly is movably arranged between the pre-embedded bracket and the socket box, and the socket cover and the socket box are connected by the screws.

2. The flush mounted wall socket according to claim 1, wherein the pre-embedded bracket is provided in different styles and specifications.

3. The flush mounted wall socket according to claim 1, wherein the connection assembly is provided with spacers and springs.

4. The flush mounted wall socket according to claim 3, wherein numbers of the spacers, the springs and the screws are not limited, and the numbers of the spacers, the springs and the screws are consistent.

5. The flush mounted wall socket according to claim 1, wherein the socket cover is fixedly provided with an access hole in the middle in addition to conventional holes, and the socket cover is round and square in shape.

6. The flush mounted wall socket according to claim 1, wherein connection between the socket box and the socket cover is magnet adsorption or direct mounting.
